(19) United States
(12) Patent Application Publication
(10) Pub. No.: US 2019/0002155 A1
(43) Pub. Date: Jan. 3, 2019

(54) CONTAINER AND METHOD OF MANUFACTURING THEREOF

(71) Applicant: PLASTIC KEG CO. LIMITED, Chorley (GB)

(72) Inventor: Jim Kelly, Chorley (GB)

(21) Appl. No.: 16/060,411

(22) PCT Filed: Dec. 5, 2016
(86) PCT No.: PCT/GB2016/053818

§ 371 Date: Jun. 7, 2018

(30) Foreign Application Priority Data
Dec. 7, 2015 (GB) 1521509.8

(51) Int. Cl. B65D 8/02; B67D 1/08

(52) U.S. Cl. CPC B65D 11/08; B29C 49/4273; B67D 1/0805

(57) ABSTRACT

A container includes a plastics pressure vessel defining a hollow interior volume suitable for containing a quantity of a liquid, and comprising an inlet/outlet aperture extending through a wall thereof, and being in fluid communication with the hollow interior thereof. An insert, manufactured from a different, harder plastics material to that of the pressure vessel is provided within the inlet/outlet aperture, which is sealingly united (fused) with a periphery of the container to be securely retained therein. The plastics pressure vessel can be blow moulded around the insert so as to sealingly unite or fuse with the insert in the region of the interface between the different materials of which vessel and insert are formed. The insert may have a series of flats machined or otherwise formed around and into its outer circumferential surface so the insert is inhibited from axially or rotationally displacing relative to the pressure vessel.

This application is a U.S. National Phase application of International Application PCT/GB2016/05381 filed Dec. 5, 2016, which claims priority to GB Application 1521509.8 filed Dec. 7, 2015, the entire disclosures of which are hereby incorporated by reference herein in their entireties.

This invention relates to containers, and in particular, but without limitation, to containers suitable for use as beer kegs.

Kegs are ubiquitous in the brewing industry and are used to transport quantities of beer from the brewery to retail establishments, such as pubs, bars and restaurants. The beer is stored in the keg under pressure, and so the keg needs to be able to withstand the internal hydrostatic pressure, as well as being sufficiently strong and durable to withstand the rough handling that occurs in the brewery (where kegs are rolled, dropped and bumped around as they move along a filling line, for example) and during transport (where kegs are often dropped off the back of delivery lorries and/or into basements from street level, for example). It is therefore imperative that a beer keg is able to safely contain its pressurised gas and/or liquid contents, even when subjected to repeated impacts, vibration and shaking.

A further requirement of beer kegs is their ability to be re-used. In order to meet this objective, they must be sufficiently robust and durable to withstand repeated filling, transportation, storage and emptying cycles. Beer kegs, due to the nature of their contents (normally beer), need to be sterili sable (usually by using pressurised steam injected into the interior of the keg on the filling line). A thither requirement of a beer keg is its resistance to absorbing, or adsorbing on its interior surfaces, contaminants that may taint or spoil the contents.

Traditionally, therefore, beer kegs comprise a stainless steel pressure vessel with an inlet/outlet aperture through which it can be filled, cleaned and emptied. The inlet/outlet aperture generally comprises an internal screw thread for screw-threading receiving a corresponding external screw thread of a “spear”, which spear is generally brewery-specific (i.e. each brewery uses its own type of spear to prevent their kegs from being used by other breweries, or vice-versa). The spear comprises a screw threaded boss that engages with the inlet/outlet aperture of the keg, and which comprises a tube that extends into the interior of the keg's pressure vessel. The function and construction of keg spears is largely outside the scope of this disclosure, other than to note that it sealingly engages with the keg via a screw-threaded connection.

The vast majority of beer kegs also comprise circumferential ribs extending around the main body of the pressure vessel, which facilitate rolling the keg over a floor or ground surface. A base ring is also usually provided, which is typically welded to the base of the pressure vessel, to stabilise it when the keg is stood upright. An upper ring is also usually provided, surrounding the inlet/outlet aperture of the keg, to facilitate manual handling (i.e. comprising handle portions) and to protect the inlet/outlet aperture and the external part of the spear.

A stainless steel keg will also usually comprise a pressure-relief safety valve. This is usually formed as a line of weakness on the base of the pressure vessel so that in the event of an internal over-pressure, the line of weakness breaks preferentially, thereby discharging the keg's contents out through the base (i.e. away from bystanders) in a relatively controlled manner.

Metal, and in particular, stainless steel kegs suffer from a number of well-known drawbacks, including: the considerable weight of metal kegs can be problematic from both a manual handling, and a cost-of-transportation, perspective; and the high cost of metal kegs and their high “scrap metal” value, which makes them very susceptible to theft.

In an attempt to address one or more of the above problems, it has been proposed to manufacture beer kegs out of high-impact polymers, typically polyethylene and polypropylene, which are thermoplastic materials that can be readily injection- or blow-moulded.

Examples of known containers are described in U.S. Pat. No. 4,589,536A [BORN, 20 May 1986]; and in EP0934815A2 [JMK NT INC, 11 Aug. 1999].

However, when manufacturing the pressure vessel of a plastic beer keg from thermoplastic materials, it is not possible to form the internal screw threading of the inlet/outlet aperture to a sufficiently high tolerance to reliably accept a spear. On solution is to blow-mould the pressure vessel with a “blank” inlet/outlet aperture, which can be tapped subsequently to produce the requisite internal thread, but due to the nature of the polymer from which the pressure vessel is manufactured, the threads tend to break when the vessel is pressurised, potentially leading to catastrophic failure. Put simply, plastic kegs manufactured to mimic metal kegs, have been found to be unsuitable in actual use.

In order to overcome the de threading problem outlined above, it has also been proposed to provide re-manufactured kegs, which comprise a plastics outer shell that is adapted to receive a disposable plastic film liner to which a screw threaded inlet/outlet aperture is bonded. In these types of plastic keg, the outer shell provides the requisite durability and impact resistance, and effectively contains the liner, which expands upon filling to bear against the inner walls of the outer casing. After each use, the keg is stripped down by removing the liner, and a replacement liner is fitted prior to re-filling. However, these known kegs produce waste (i.e. the discarded liners) during each fill cycle, and it is also necessary to recover and re-fit the spears during each fill cycle, which tends to be a labour-intensive procedure.

A need therefore exists for a solution to one or more of the above problems and/or an alternative to kegs that are currently available.

Various aspects of the invention are set forth in the appended independent claims. Optional or preferred features of the invention are set forth in the appended defendant claims.

By providing an insert manufactured from a different material to that of the pressure vessel, it is possible to manufacture the pressure vessel from a relatively inexpensive, high-impact polymer, such as polyethylene or polypropylene (thus meeting the mechanical requirements of the pressure vessel) whilst at the same time being able to manufacture the insert from a different material (such as ABS) that is more suited to forming a thread for screw threading receiving, in use, a connector, such as a spear.

In other words, the invention provides somewhat of a hybrid container falling somewhere between a completely moulded plastics container (which is unsuitable for subsequent attachment of a spear) and a (high cost) metal keg with its precision neck. By making the container from several components, which are sealingly united, or fused, together during the manufacturing process, the invention suitably provides the best of both worlds, that is to say: a low cost container and a precision neck to which a spear can be affixed.

A thither possible advantage of the invention is one of rationalisation, by which a manufacturer could have one tool for making the pressure vessel, and a stock of different inserts that can be fitted to the containers to suit different customer's needs. This advantageously obviates the need for a separate tool for the pressure vessels for each customer.

Suitably, the pressure vessel is manufactured via a blow-moulding process, which process is particularly suited to the manufacture or relatively large, hollow plastics components. Suitably, the pressure vessel is manufactured from polypropylene, nylon or other recyclable or reprocessable polymer material which meet one or more of the aforementioned requirements of the pressure vessel, which in particular include some degree of shock and shatter resistance.

The insert is manufactured from a plastics material, being most preferably of much higher density (and thus structural strength and rigidity) than the material from which the pressure vessel is manufactured, and in which a screw thread can be formed, either as part of the moulding process or thereafter by tapping or other screw thread formation process. Suitably, the insert is manufactured from a plastics material that is compatible with the plastics of the pressure vessel so that the two can be sealingly united.

Suitably, the insert is manufactured from a material such as high density polyethylene (HDPE), an acetal-based polymer with glass bead or glass fibre reinforcement, or a high strength glass-filled nylon material, such meeting one or more of the above requirements, in particular by being structurally much stronger and more rigid (still elastic but much less so) than the material of which the pressure vessel is constituted. Alternatively, an example is the HDPE known as “Hostalen® ACP 6541A UV” available from LyondellBasell® Industries NV.

Suitably, the insert is generally tubular and may comprise a flange portion. The flange portion, where provided, suitably provides a region of increased surface area for sealingly uniting the insert to the pressure vessel. In preferred embodiments of the invention, the flange is receivable in a corresponding annular recess surrounding the periphery of the pressure vessel's inlet/outlet aperture. Such a configuration suitably aligns and/or temporarily retains and/or forms a mechanical connection (e.g. an interference fit) between the insert and the pressure vessel. In certain embodiments, particularly when the pressure is blow-moulded in-situ around the insert, said interference fit will arise naturally as a result of the contraction of the polymer of the pressure vessel as it cools after the blow-moulding process.

The flange, where provided, is suitably located at least partially within the hollow interior of the pressure vessel to resist outward movement or subsequent removal of the insert.

The pressure vessel is sealingly united with the insert, and this can be accomplished in a number of ways. For example, where the insert and pressure vessel are manufactured from similar and/or compatible materials, they may weld or fuse together during the manufacturing process to form the requisite seal. In certain embodiments (e.g. when the pressure vessel is being blow-moulded around the insert) the polymer material of the pressure vessel is plastically deformed while at elevated temperature. As the plastic comes into contact with the relevant surface of the insert, it can cause the material of the insert to soften to some degree, and thus the materials of the respective components may meld together in the region of their interface. Such a physical (or indeed possibly chemical, should the interaction between the materials in the region of their interface be chemical in nature) bond between the respective components would significantly reduce the likelihood that the insert might detach itself from the pressure vessel and start to rotatingly slip relative to the pressure vessel when an operative attempts to screw a spear into the threaded aperture of the insert, particularly as the spear is tightened therein.

Additionally or alternatively, the insert may be forcibly welded to the pressure vessel, for example, using ultrasonic welding. Additionally or alternatively, a bead or film of solvent and/or adhesive may be applied to the insert and/or the periphery of the inlet/outlet aperture during the manufacturing process such that the two become sealingly bonded together.

The insert comprises a neck around the exterior surface of which, said neck exterior surface being that surface with which a periphery of the inlet/outlet aperture of the pressure vessel is sealingly united, are provided one or more rotationally (and optionally circumferentially or radially) asymmetric formations which mechanically interact with the aperture periphery of the pressure vessel to prevent the insert from disengaging with, and rotating relative to the pressure vessel aperture in which it is disposed. Various different formations are possible, but one particularly useful formation is a continuous bead in which a plurality of recessed flats are machined, formed or otherwise provided. An alternative (and equivalent) formation would be a discontinuous bead. Regardless of the particular shape of the formation(s), their purpose is the same—to completely prevent (except in the event of catastrophic failure) the insert from rotationally slipping within and relative to the pressure vessel aperture in which it is seated.

For instance, In the case where the pressure vessel is blow-moulded such that the polymer thereof is plastically deformed onto, around, and within said formation(s), and then sets in place, the insert is completely secured within the pressure vessel aperture, both axially (by the radial flanges provided above and below the neck of the insert and between which a corresponding neck of the pressure vessel is formed and thus disposed), and also rotationally (by virtue of the said formation(s) being essentially embedded within said neck of the pressure vessel). For the avoidance of doubt, it should be mentioned that the asymmetry of the formations should be such that there is at least some difference in shape, depth, or width of the formation provided at one circumferential position around the neck as compared to the formation provided at one, or any other circumferential position.

Suitably, the container comprises an outer casing. The outer casing, where provided, may serve, in use, to protect the pressure vessel. The outer casing may comprise circumferential ribs extending around it to facilitate, in use, rolling the container over a floor or ground surface. The outer casing may further comprise a base portion adapted, in use, to stabilise the container when it is stood upright. The outer casing may further comprise upper portion adapted, in use, to facilitate manual handling of the container, and/or to protect the inlet/outlet aperture and the external part of an attached spear. The upper portion may additionally comprise handle portions.

Suitably, the outer casing, where provided, comprises three parts, namely a base portion, a waistband portion and an upper portion. The aforementioned three casing portions are suitably united by clip fittings and/or by ultrasonic welding and/or by an adhesive. By making the outer casing in three parts, a further possible advantage of rationalisation may flow from the invention, by which a manufacturer could use the same base and/or upper portions on every container, but vary the waistband portion to suit different customer's needs, for example, by providing customer-specific colours, branding, embossing, debossing etc.

The container of the invention may also comprise a pressure-relief safety valve.

Suitably, the thermoforming process comprises a blow moulding process. The method may thither comprise the step of forming an internal screw thread on an interior surface of the tubular insert. The method may thither comprise the step of applying a bead or film of solvent or adhesive to the insert and/or to the periphery of the pressure vessel's inlet/outlet aperture. The method may thither comprise the step of welding, for example ultrasonically welding, the insert to the periphery of the pressure vessel's inlet/outlet aperture.

The method may thither comprise the step of forming, and affixing, an outer casing around, the pressure vessel. Suitably, the outer casing is formed in two or more parts that can be placed around the pressure vessel and joined or united subsequently, for example, by clip-fitting together and/or using an adhesive and/or using ultrasonic welding.

Preferred embodiments of the invention shall now be described, by way of example only, with reference to the accompanying drawings in which:

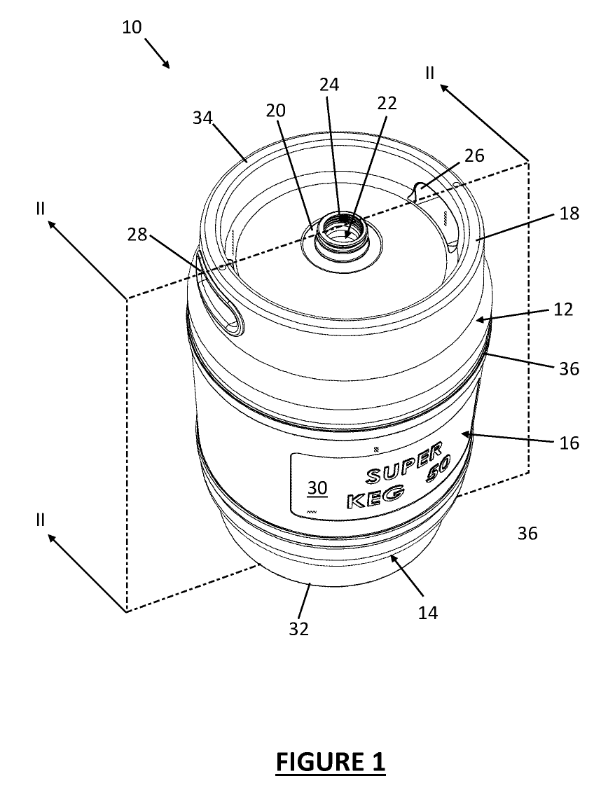

FIG. 1 is a perspective view of a container in accordance with the invention;

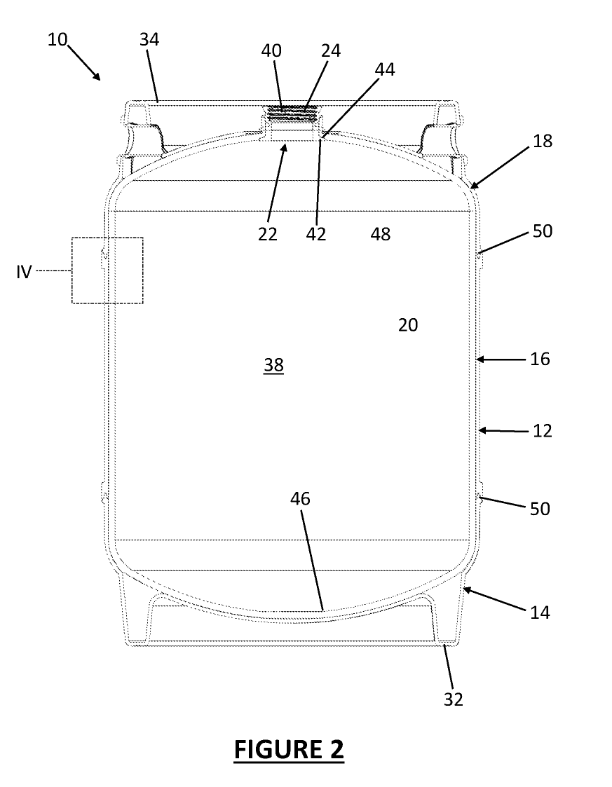

FIG. 2 is a cross-section of FIG. 1 on II;

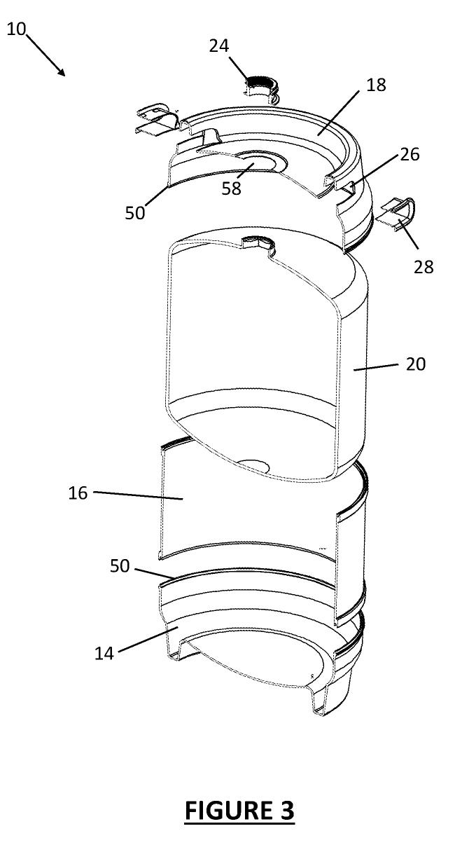

FIG. 3 is an exploded, perspective, cross-sectional view of FIG. 1 on II;

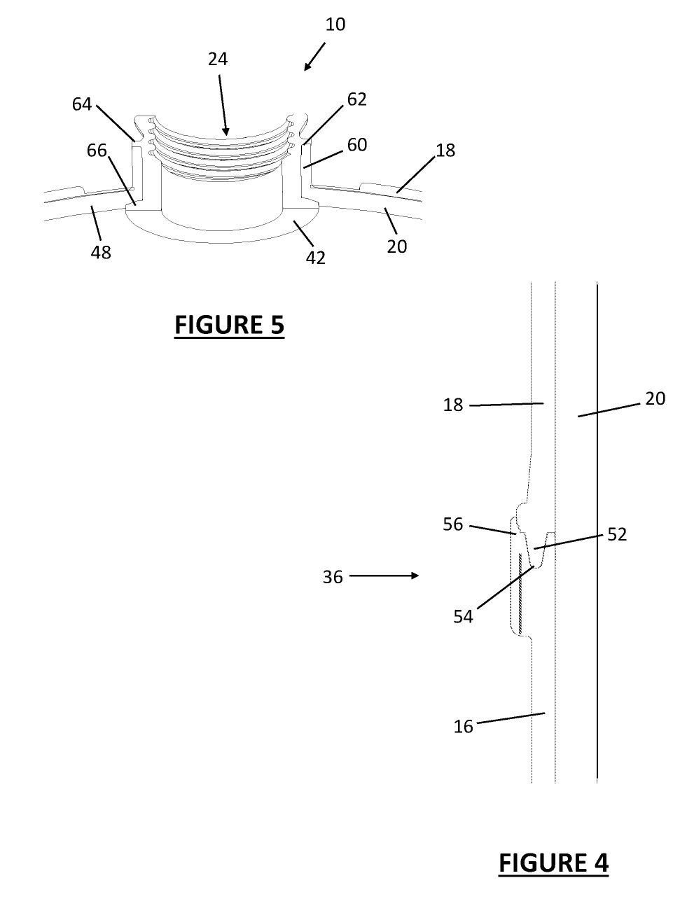

FIG. 4 is a close-up view of FIG. 2 on the sharing the detail of the join;

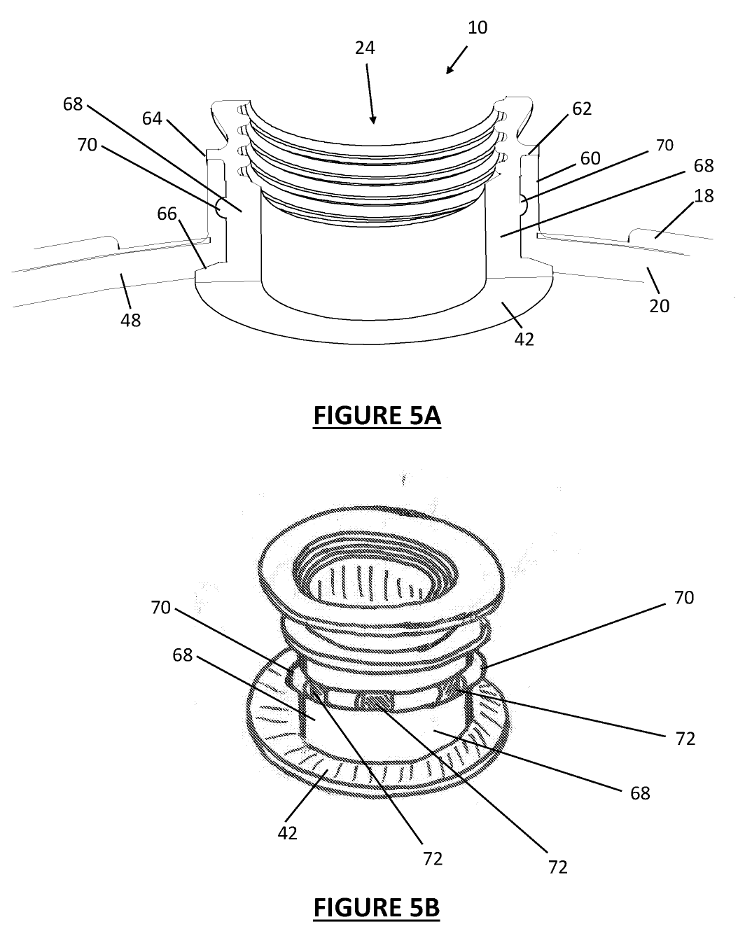

FIG. 5 is a close-up perspective, cross-sectional view of the inlet/outlet aperture of the container of FIG. 1 with insert in place;

FIGS. 5A, 5B show close-up views of an alternative embodiment of the insert shown in section in FIG. 5,

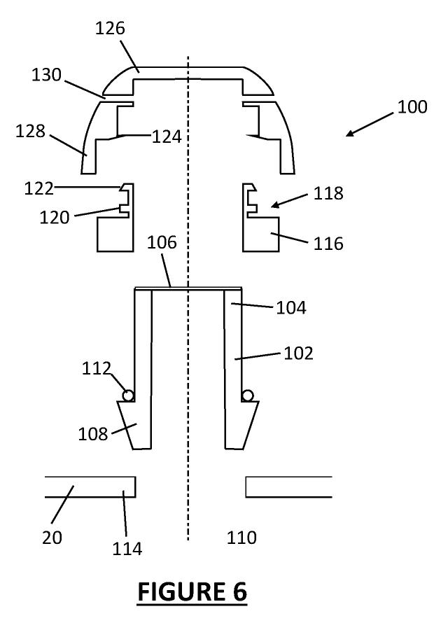

FIG. 6 is an exploded, schematic cross-sectional view of a pressure relief valve in accordance with aspect of the invention;

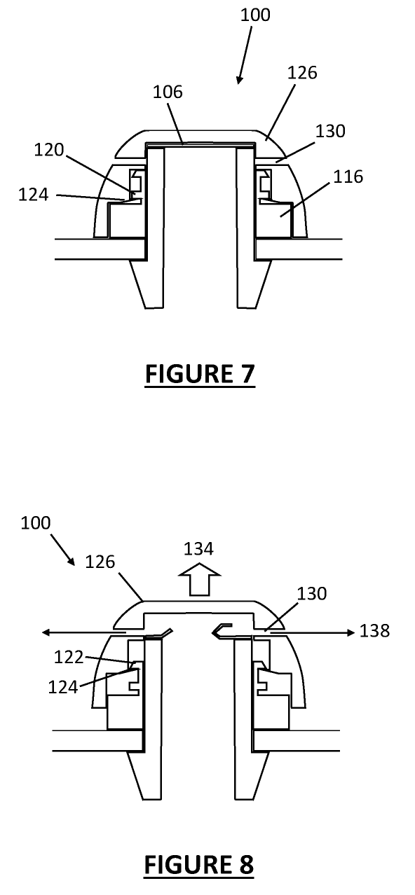

FIG. 7 is a cross-sectional view of the pressure relief valve of FIG. 6 in an un-ruptured state;

FIG. 8 is a cross-sectional view of the pressure relief valve of FIG. 6 in a ruptured state;

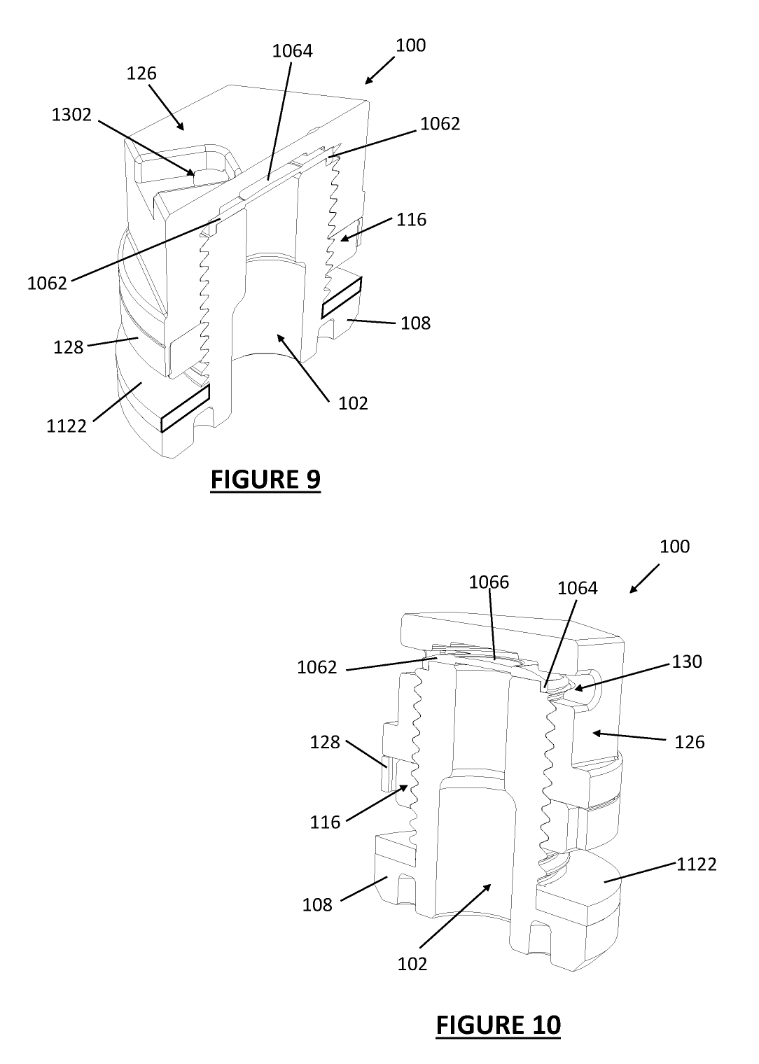

FIG. 9 is a cross-sectioned perspective view of an embodiment of a pressure relief valve according to the invention; and

FIG. 10 is a cross-sectioned perspective view of another embodiment of a pressure relief valve according to the invention.

In FIG. 1 of the drawings, a container 10 in accordance with the invention comprises an outer casing 12 formed from a lower base part 14, a generally tubular central waistband portion 16 and an upper casing portion 18. The casing 12 encases a plastics pressure vessel 20 having an inlet/outlet aperture 22 through which the container 10 can be filled and emptied in use. The inlet/outlet aperture 22 is fitted with a generally tubular insert 24 manufactured from a different plastic material to that of the pressure vessel 20.

The upper casing portion 18 comprises a pair of diametrically opposed cut-outs forming handles 26 into which have been inserted clip-fitting, slidably receivable grip portions 28. The waistband portion 16 of the outer casing 12 also comprises a display portion 30 onto which indicia (such as advertising or branding) can be printed, embossed or debossed, as required.

It will be noted from FIG. 1 that the base portion 14 of the outer casing 12 has a lower peripheral edge 32 that forms a stable base to support the container 10 when it is stood upright, as shown. Likewise, the upper casing portion 18 also comprises a generally flat rim 34 that enables the container 10 stably stood when inverted also, although it will be appreciated that the container 10 is not generally stored upside down.

The central waistband portion 16 of the outer casing 12 comprises a pair of circumferential ridges 36 which facilitate rolling the container 10 when it is laid on its side.

The pressure vessel 20 and the outer casing, handles 28 and the insert 24 are all manufactured from plastics materials, which makes the container 10 considerably lighter than a stainless steel equivalent.

Turning now to FIG. 2, which is a cross-section of FIG. 1 on II, it can be seen that the pressure vessel 20 fits snugly inside the outer casing 12 and that the interior profile of the casing 12 substantially corresponds to the outer profile of the pressure vessel 20. It should be noted, however, that the cross-section of FIG. 2 shows the container 10 after having undergone a number of filling/emptying cycles. Initially, the pressure vessel 20 is made slightly smaller than the outer casing 12 and this is deliberately so to accommodate the expansion and “permanent set” that occurs when the pressure vessel, being manufactured from plastics, is first steam cleaned internally. It will be apparent to those skilled in the art that the interior of a beer keg, for example, is cleaned between uses using high-pressure, superheated steam. However, where the pressure vessel 20 is manufactured from plastics, there will be a tendency for it to expand slightly the first time this occurs, which introduced a slight increase in size, which expansion becomes “permanently set” into the plastic, i.e. the expansion does not re-contract with subsequent use of the container 10.

It will be seen from FIG. 2 that the pressure vessel 20 has a hollow interior volume 38, which is suitable for retaining a quantity of liquid, such as beer (not shown), in use. The hollow interior volume 38 of the pressure vessel 20 can be filled or emptied via the inlet/outlet aperture 22 at its upper end.

The insert 24 is formed as a generally tubular plastics component, which comprises an internal thread 40 around its upper periphery, which is designed to engage with a complementary external screw thread of a dispensing spear (not shown). The lower end of the insert 24 terminates in an outwardly radially projecting flange 42, which seats in a correspondingly shaped recess 44 surrounding the periphery of the inlet/outlet aperture 22 of the pressure vessel 20.

The inlet/outlet aperture's periphery and the flange portion 44 of the insert 24 are fused together during the manufacturing process of the pressure vessel 20. Specifically, the pressure vessel 20 is blow moulded from a tube of softened plastics material (the blank), which is lowered into a mould. A first crimping device (not shown) clamps around the outside of the softened blank to pinch the bottom part 46 of the pressure vessel 22 together during the moulding process. The insert 24 is pre-located inside the mould and a second crimping device (not shown) draws the upper parts 48 of the softened blank together around the outside of the insert 24 during the moulding process. Then, pressurised air or gas is blown into the interior volume 38 formed by the softened blank to form the shape of the pressure vessel 20 by outward expansion onto the interior form of the mould. Because the blank for the pressure vessel 20 is in a softened state during this procedure, it is able to form an intimate joint with the outside surface and/or flange 42 of the insert 24. Furthermore, because the blank is in a semi-solid-state during the moulding process, it is able to fuse and sealingly bond to the flange portion 42 of the insert 24 during the moulding process.

It will be appreciated this manufacturing technique forms a unitary structure comprising the shaped pressure vessel 20 and the now integrally formed insert 24.

The pressure vessel 20 is typically manufactured from a thermoplastic material such as polyethylene or polypropylene, whereas the insert 24 is typically manufactured from a harder, machinable material, such as ABS. Therefore, the pressure vessel provides a tough, durable and waterproof enclosure for the contents of the container 10 in use, whereas the insert 24 provides a much harder component, which can be accurately machined, moulded or threaded to receive a dispensing spear (not shown), in use.

It can be seen from FIGS. 2 and 3 in particular, that the outer casing 12 of the container 10 comprises a lower base portion 14, a central waistband portion 16 and an upper portion 18 which are united by complimentary push-fit connections 50 that extend around their upper and/or lower peripheral edges 50.

FIG. 4 of the drawings is a close-up view of FIG. 2 on IV and shows how the upper casing portion 18 comprises a lower peripheral edge comprising a circumferential lip 52 that seats within a corresponding circumferential channel 54 disposed on the upper edge of the waistband portion 16 or vice versa. The upper peripheral edge of the waistband portion 16 terminates in a radially outwardly located lip portion 56, which overlaps slightly lower peripheral edge of the upper portion 18 of the casing 12. The overlapping portion 56 is shaped and configured for optimal ultrasonic welding of the two parts 16, 18 Therefore, there is both a mechanical interconnection between the upper casing portion 18 and the waistband portion 16 as well as an ultrasonic weld fusing the two together. This results in a strong, durable interconnection which should last the lifetime of the container 10. Alternatively, the lip may comprise a clip formation adapted to positively engage a corresponding formation of the circumferential channel. The same is also true of the lower casing portion 14 and the waistband portion 16 of the outer casing.

Suitably, the upper, lower and waistband portions comprise a radially outwardly disposed lip portion, which overlaps the join line between the lower portion and the waistband portions; and the upper portion and the waistband portion.

Conveniently also, the overlapping portions 56 form the radially outwardly projecting ribs 36 previously mentioned, to facilitate rolling the container 10 across a floor or ground surface.

Turning back to FIGS. 2 and 3 of the drawings, it can be seen how the handle inserts 28 simply clip into corresponding cut-outs 26 in the upper casing portion 18 and how the upper casing portion 18 comprises a central through-hole 58 that surrounds the neck of the pressure vessel 20.

Turning now to FIG. 5 of the drawings, which is a close-up view showing the connection between the insert 24 and the inlet/outlet aperture of the pressure vessel 20, it can be seen that during the manufacturing process, the upper part 48 of the pressure vessel 20 is crimped to form a neck portion 60 that folds up around the sidewall of the insert 24. The upper peripheral edge 62 of the neck 60 abuts a small radially projecting flanged portion 64 of the insert and thus forms a neat termination to the neck 60 of the pressure vessel 20.

It can also be seen in FIG. 5 of the drawings how the lower peripheral flange 42 of the insert 24 is slightly wider than the neck 60 of the pressure vessel 20 thereby inhibiting removal or outward displacement of the insert post-manufacture.

It can also be seen from FIG. 5 of the drawings how the upper surface 66 of the peripheral flange 42 of the insert 24 is slightly chamfered and this serves to centralise insert 24 within the neck 60 of the pressure vessel 20 during the manufacturing process.

Referring briefly to FIGS. 5A, 5B, insert 24 comprises a neck portion 68 (present also in FIG. 5 but not referenced) around the exterior surface of which is provided a bead 70 in which are provided, by machining, forming or by some other process, a series of flats 72 to render the bead rotationally asymmetric, as compared to other parts thereof, e.g. flanges 42, 64. The rotationally asymmetric bead 70 thus provides a means whereby a hot thermoplastic polymer material, such as may be used in the blow-moulding of the pressure vessel, can flow around the bead and into the flats provided therein. Under suitable pressure, and after the moulded polymer material has cooled or at least partially set, not only will the exterior surface of neck 68 and the material of the pressure vessel be sealingly united to one another, but un-flattened portions of the bead 70 will be effectively embedded within the set polymer material to a greater extent than the flats, and by so being, they provide an exceptionally strong mechanical connection therewith, said connection being one which effectively completely prevents the insert from ever rotating within the aperture of the pressure vessel in which it is seated (except upon catastrophic failure of either insert or pressure vessel in the region of the connection).

It is to be specifically noted also from FIGS. 5, 5A, 5B that the flange 42 is large in diameter than the flange portion 64, these being the respective parts of the insert 24 between which the neck 60 of the pressure vessel is disposed, ideally having by being formed therebetween as part of the blow moulding process. This diametric differential is mechanically important as it further improves the axial strength of the connection between insert and pressure vessel such that, except in catastrophic circumstances, it is effectively impossible for the insert to escape from the inlet/outlet aperture of the pressure vessel, for example by bursting or blowing out. Indeed, in test conditions, it has been shown that this connection is so mechanically strong that the entire pressure vessel would fail first, e.g. by bursting, before the connection between insert and pressure vessel would fail. Furthermore, the flanges 42, 64 effectively axially restrict the flow of plastically fluent polymer material during the forming process, and thus effectively define the ultimate axial dimensions of the neck 60 of the pressure vessel which is received therebetween. Thus, the flanges 42, 64 and their particular configuration can be considered as important aspects of the present invention. Indeed, the insert alone, and the various features thereof described above, are to be considered as being an independent aspect of the present invention.

It will be appreciated that the pressure vessel 20 will require a pressure relief valve to safeguard against a risk of explosion, and a pressure relief valve suitable for use in conjunction with a container according to this invention is shown in FIGS. 6, 7 and 8 of the drawings.

Referring first of all to FIG. 6, which is a schematic, exploded cross-sectional view of a pressure relief valve 100 in accordance with the invention, comprises a generally tubular main body portion 102 whose upper edge 104 is sealed shut by a thin, frangible membrane 106 and whose lower end terminates in a barb-like flange portion 108 that can be tapped through a suitably sized hole 110 in a wall of a pressure vessel 20.

An O-ring seal 112 is located on top of the barb portion 108 such that once the main body portion 102 has been inserted through the hole 110, it can be raised such that the O-ring seal 112 seats correctly, and is trapped between the upper part of the barb portion 108 and the underside 114 of the sidewall of the pressure vessel 20.

A screw threaded locking ring 116 is then screwed onto the outside of the main body portion 102 to clamp the periphery of the hole 110 in the pressure vessel 120 between the barb portion 108 and the locking ring 116.

The locking ring 116 comprises a stepped upper portion 118, which comprises two axially spaced apart edges 120, 122 that are adapted to engage an internal bath ring 124 of a push-on cover 126 of the valve 100.

The push-on cover 126 is manufactured from a single piece of injection moulded plastics material, such as polyethylene, and has a lower skirt portion 128 that covers the locking ring portion 116 thereby preventing tampering with the locking ring 116 after installation.

The cover portion 126 also comprises a number of vent apertures 130 which, when the cover portion 126 is pushed onto the locking ring, as shown in FIG. 7, lie at a level below the frangible membrane 106.

Referring to FIG. 7 of the drawings, which shows the valve in-situ in normal use: the cover portion 126 protects the frangible membrane 106 from damage, as well as preventing tampering of the locking ring 116 and providing a visual indication that everything is in order. However, in the event of an over-pressure situation, as shown in FIG. 8, the hydrostatic pressure 132 within the pressure vessel 20 will exceed a predetermined rupture pressure of the frangible membrane 106 causing it to break, as shown in FIG. 8. The fluid within the pressure vessel 20 will thus exert an upward force 134 on the cover portion 126 causing it to rise as shown in FIG. 8, thus exposing the vent apertures 130 and permitting the fluid to escape as shown by arrows 138, thereby relieving the pressure within the pressure vessel 20. It will be noted, from FIG. 8, that the barb ring 124 of the cover portion 126 have disengaged from the lower edge 120 and has now engaged against the upper ledge 122 of the locking ring 116.

In certain embodiments of the invention, the locking ring 116 is manufactured from an anodised metal ring, for example being coloured red, such that once the cover portion 126 has popped-up during a pressure relief event, it will become apparent to an observer that something is amiss because the red locking ring 116 will be visible from outside the valve 100. It will also be noted from FIG. 8 of the drawings, in particular, that the escaping fluid 138 is directed sideward from the pressure relief valve 100 and that the cover portion 126 prevents it from blowing straight up, which might otherwise injure bystanders.

Embodiments of the pressure relief valve are shown in FIGS. 9 and 10 of the drawings, in which identical or equivalent features to those described in FIGS. 6, 7 and 8 above are identified with identical reference signs to avoid repetition. It can be seen from FIGS. 9 and 10 that the O-ring seal 112 has been replaced by a flat, annular seal 1122. Also, in FIG. 10, the vent aperture 130 extends sidewardly through the cover portion 126, whereas in FIG. 9, it 1302 extends through the side and top walls of the cover portion.

It can also be seen in FIGS. 9 and 10, that the frangible membrane 106 is formed as a plastics disc 1062 having an outer peripheral lip 1064 that seats in a rebate of the tubular main body portion 102. The disc 1062 has a central portion 1066 that is thinner than the periphery of the disc to form an area of weakness that ruptures preferentially in the event of an over-pressure situation.

The invention is not restricted to the details of the foregoing embodiments, which are merely exemplary of the invention. For example, and shapes, materials or dimensions, whether explicit or implied, are illustrative of the invention, except where they are mentioned in the appended claims.

1. A container (10) comprising: a plastics pressure vessel (20) defining a hollow interior volume (38) suitable, in use, for containing a quantity of a liquid, the pressure vessel comprising an inlet/outlet aperture (22) extending through a wall of, and being in fluid communication with the hollow interior of, the pressure vessel (20); and an insert (24) manufactured from a different material to that of the pressure vessel (20), wherein the insert (24) is fused with a periphery of the inlet/outlet aperture (21) of the pressure vessel (20), in use.

2. The container (10) of claim 1, wherein the pressure vessel (20) is manufactured via a blow-moulding process.

3. The container (10) of claim 1 or claim 2, the pressure vessel (20) is manufactured from a material in the group consisting of: polypropylene, nylon, and any other recyclable or re-processable polymer.

4. The container (10) of any preceding claim wherein the insert (24) is manufactured from a plastics material of relatively higher density than the material from which the pressure vessel (20) is manufactured.

5. The container (10) of any preceding claim wherein the insert (24) is manufacture from high-density polyethylene (HDPE).

6. The container (10) of any preceding claim, wherein the pressure vessel (20) and insert (24) are fused by welding the insert (24) to the periphery of the inlet/outlet aperture (22).

7. The container (10) of any preceding claim, wherein the pressure vessel (20) and insert (24) are fused by as a result of the melding of the materials from which they are constituted.

8. The container (10) of any preceding claim, wherein the insert (24) is generally tubular and comprises a flange portion (42, 66) whose outer diameter is greater than the diameter of the inlet/outlet aperture (22).

9. The container (10) of claim 8 wherein the insert (24) comprises a neck extending upwardly from the flange portion (42, 66) which is provided at one end of said neck portion, and a second flange portion (62) provided around said neck portion at some axial position remote from the first flange portion (42, 66), the diameter of said first flange portion being greater than the diameter of said second flange portion (62).

10. The container (10) of claim 9, wherein a periphery of the inlet/outlet aperture (22) comprises a recess adapted to receive the flange of the insert (24).

11. The container (10) of any preceding claim, wherein the insert (24) comprises a neck portion around the exterior surface of which is provided one or more rotationally asymmetric formations (72).

12. The container (10) of claim 11, wherein the rotationally asymmetric formations (72) comprises a bead in which flats have been one or more of: machined, formed, deformed, pressed, and hot-worked.

13. The container (10) of any preceding claim, further comprising an outer casing (12).

14. The container (10) of claim 13, wherein the outer casing (12) surrounding the plastics pressure vessel (10) comprising a base portion (14), a generally tubular central waistband portion (16) and an upper portion (18).

15. The container (10) of claim 14, wherein the upper portion (18) comprises a lower peripheral edge comprising a circumferential lip (52) that seats within a corresponding circumferential channel (54) disposed on an upper edge of the waistband portion (16), or vice-versa.

16. The container (10) of claim 14 or claim 15, wherein the lower portion (14) comprises an upper peripheral edge comprising a circumferential lip that seats within a corresponding circumferential channel disposed on a lower edge of the waistband portion, or vice-versa.

17. The container (10) of claim 15 or claim 16, wherein the circumferential lip (52) comprises a clip formation (56) that positively engages a corresponding formation of the circumferential channel (54).

18. The container (10) of claim 15, 16 or 17, wherein the circumferential lip (52) is ultrasonically welded to the circumferential channel (54).

19. The container (10) of any of claims 15 to 18, wherein any one of the upper (10), lower (14) or waistband (16) portions comprises a radially outwardly disposed lip portion (56) which overlaps the join line between the lower portion (14) and the waistband portion (16); or the upper portion (18) and the waistband portion (16).

20. The container (10) of claim 19, wherein the lip portion forms a circumferential rib (36) extending around the outer casing (12).

21. The container (10) of any of claims 13 to 20, wherein the outer casing (12) comprises a base portion (14) adapted, in use, to stabilise the container (10) when it is stood upright.

22. The container (10) of any of claims 13 to 21, wherein the outer casing (12) comprises an upper portion (34) adapted, in use, to facilitate manual handling of the container (10), and/or to protect the inlet/outlet aperture (22) and the external part of an attached spear.

23. The container (10) of claim 22, wherein the upper portion (18) comprises handle portions (28).

24. The container (10) of any preceding claim, further comprising a pressure relief valve (100).

25. The container (10) of claim 24, wherein the pressure-relief valve (100) comprises: a tubular main body portion (102) adapted, in use, to sealingly affix to, and extend through, a wall of the plastics pressure vessel, a frangible membrane (106) sealingly closing an end of the tubular main body portion (102), and a cover portion (126) overlying the frangible membrane (106), the cover portion (126) comprising at least one vent aperture (130).

26. The container (10) of claim 25, wherein the cover portion (126) is slidingly affixed to the main body portion (102).

27. The container (10) of claim 26, wherein the cover portion (126) is moveable between a first position in which the vent aperture (130) is closed by the main body portion (102), and a second position in which the vent aperture (130) forms a conduit providing fluid communication between the frangible membrane (106) and the exterior of the cover portion (126).

28. The container (10) of any of claims 24 to 27, wherein the main body portion (102) comprises a barbed flange portion (108) that can be push-fitted into a suitably sized through hole (110) in a wall (114) of the pressure vessel (20) and a locking ring (118) screwed onto the outside of the main body portion (102) to clamp the periphery of the hole (110) of the pressure vessel (20) between the barbed flange (108) and the locking ring (118).

29. The container (10) of claim 28 when dependent on claim 27, wherein the cover portion (126) comprises a skirt portion (128) that overlies the locking ring (118) when the cover portion (128) is in the said first position.

30. A method of manufacturing a container comprising: a hollow plastics pressure vessel (20) suitable, in use, for containing a quantity of a liquid, manufactured of a first plastics material, the pressure vessel (20) comprising an inlet/outlet aperture (22) and a generally tubular insert (24) manufactured of a second material that is a different material to the said first material, the method comprising the steps of: locating the insert (24) in a receiving portion of a mould, the location of the receiving portion corresponding to that of the inlet/outlet aperture (22); thermoforming pressure vessel within the mould and around the insert (24), whereby, during forming the pressure vessel (20), the insert (24) is fused with a periphery of the pressure vessel's inlet/outlet aperture (22).

31. The method of claim 30, wherein the thermoforming process comprises blow moulding.

32. The method of claim 31, wherein pressure vessel (20) is blow moulded from a blank comprising a softened tube of thermoplastic, which is lowered into a mould to which the insert (24) has been affixed, and wherein a first crimping device clamps around the outside of the blank to pinch a bottom part of the blank to form a base of the pressure vessel (20), and wherein a second crimping device draws upper parts of the blank together around the outside of the insert to form a neck, and wherein pressurised air or gas is blown into an interior volume of the blank, via the inlet/outlet aperture to form the shape of the pressure vessel (20) by outward expansion onto an interior surface of the mould.

33. The method of claim 30, 31 or 32, comprising the step of waiting for the insert and neck of the pressure vessel to fuse and sealingly bond to one another.

34. The method of any of claims 30 to 33, further comprising forming an outer casing (12) around the pressure vessel (20).

35. The method of any of claims 30 to 34, further comprising the step of forming an internal screw thread on an interior surface of the tubular insert (24).

36. The method of any of claims 30 to 35, further comprising the step of applying a bead or film of solvent or adhesive to the insert (24) and/or to the periphery of the pressure vessel's inlet/outlet aperture (22).

37. The method of any of claims 30 to 36, further comprising the step of ultrasonically welding the insert (24) to the periphery of the pressure vessel's inlet/outlet aperture (22).
